(19) United States
(12) Patent Application Publication
(10) Pub. No.: US 2026/0244943 A1
(43) Pub. Date: Aug. 20, 2026

(54) Listwise Learning to Rank

(71) Applicant: Google LLC, Mountain View, CA (US)

(72) Inventor: Gil Shamir, Sewickley, PA (US)

(21) Appl. No.: 19/489,561

(22) PCT Filed: Jun. 2, 2023
(86) PCT No.: PCT/US2023/024317

§ 371 Date: Dec. 2, 2025

(51) Int. Cl. G06N 3/096

(52) U.S. Cl. CPC G06N 3/096

(57) ABSTRACT

The present disclosure provides systems and methods that perform listwise learning to rank. The proposed training frameworks can be used to improve ranking performance in systems that benefit from better ranking of items that are recommended and shown together to a user in response to a query or request. In particular, the present disclosure provides new listwise loss functions and associated learning frameworks that can be applied to all items in a set of items potentially responsive to a request or query, which is a setting that occurs in recommendation systems, information retrieval systems, and other systems that provide items in response to a query. The proposed loss functions reduce bias in the resulting model as compared to alternative approaches, and can be used to tune between ranking objectives and pointwise prediction accuracy objectives. The proposed loss functions are also more computationally efficient than other alternatives such as an alternative pairwise approach.

### FIELD

The present disclosure relates generally to machine learning to perform item ranking. More particularly, the present disclosure relates to systems and methods that perform listwise learning to rank items in a set of items potentially responsive to a query.

### BACKGROUND

Ranking is an important aspect of various systems or applications such as recommendation systems, information retrieval systems (e.g., search engines), and/or other systems. Ranking can refer to the concept of defining a relative ordering between potential items as responses to a particular query. A query can be implicit (e.g., defined based on context) or explicit (e.g., defined based on specific natural language and/or image input (e.g., input by a user)). A query can be user-agnostic or user-specific. Thus, items that are candidates for providing as a response to the query can be ranked, where, for example, the ranking orders the items from most relevant to less relevant.

Ranking is related to but distinct from determining a relevance score for an item relative to a query. For example, while ranking defines a relative ordering between items, a relevance score for a particular item can indicate how relevant the item is for a particular query, irrespective of other potential candidate responses to the query. One example form of a relevance score is an engagement score. In some instances, an engagement score can indicate a probability that a user will “engage” (e.g., select for further evaluation, information gathering, “click through”, etc.) a particular item if it is presented as a response to a query. In some instances, relevance scores (e.g., an engagement score) can be predicted or otherwise represented using one or more labels (e.g., a single label indicating a likelihood of engagement or an actual engagement outcome).

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform listwise learning to rank with improved computational efficiency. The method includes obtaining, by a computing system comprising one or more computing devices, a training example comprising a plurality of items and a plurality of signed labels respectively associated with the plurality of items, wherein the plurality of items comprises three or more items. The method includes respectively processing, by the computing system, the plurality of items with a ranking model to respectively generate a plurality of intermediate scores respectively for the plurality of items. The method includes determining, by the computing system, a single listwise probability collectively for the plurality of signed labels based at least in part on the plurality of signed labels and the plurality of intermediate scores. The method includes evaluating, by the computing system, a ranking loss function based at least in part on the single listwise probability. The method includes modifying, by the computing system, one or more parameter values of the ranking model based at least in part on the ranking loss function.

Another example aspect of the present disclosure is directed to one or more non-transitory computer-readable media that store instructions that, when executed by a computing system, cause the computing system to perform operations. The operations include obtaining, by a computing system comprising one or more computing devices, a training example comprising a plurality of items and a plurality of signed labels respectively associated with the plurality of items, wherein the plurality of items comprises three or more items. The operations include respectively processing, by the computing system, the plurality of items with a teacher ranking model to respectively generate a plurality of intermediate teacher scores respectively for the plurality of items. The operations include respectively processing, by the computing system, the plurality of items with a student ranking model to respectively generate a plurality of intermediate student scores respectively for the plurality of items. The operations include evaluating, by the computing system, a distillation loss function based at least in part on the plurality of signed labels, the plurality of intermediate teacher scores, and the plurality of intermediate student scores. The operations include modifying, by the computing system, one or more parameter values of at least the student ranking model based at least in part on the distillation loss function.

Another example aspect of the present disclosure is directed to computing system configured to perform operations. The operations include obtaining, by the computing system, a training example comprising a plurality of items and a plurality of signed labels respectively associated with the plurality of items, wherein the plurality of items comprises three or more items. The operations include respectively processing, by the computing system, the plurality of items with a ranking model to respectively generate a plurality of intermediate scores respectively for the plurality of items. The operations include evaluating, by the computing system, a ranking loss function based at least in part on the plurality of intermediate scores and the plurality of signed labels, wherein the ranking loss function evaluates a conditional label probability that is conditioned on a union of multiple conditioning events. The operations include modifying, by the computing system, one or more parameter values of the ranking model based at least in part on the ranking loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a diagram of an example framework to perform listwise learning to rank according to example embodiments of the present disclosure.

FIG. 2 depicts a diagram of an example framework to perform listwise learning to rank according to example embodiments of the present disclosure.

FIGS. 3A-B depict diagrams of example frameworks to perform listwise learning to rank according to example embodiments of the present disclosure.

FIGS. 4A-B depict diagrams of example frameworks to perform listwise learning to rank according to example embodiments of the present disclosure.

FIG. 5A-B depict diagrams of example frameworks to perform listwise learning to rank according to example embodiments of the present disclosure.

FIGS. 6A-B depict diagrams of example frameworks to perform distillation of listwise learning to rank according to example embodiments of the present disclosure.

FIG. 7A depicts a block diagram of an example computing system according to example embodiments of the present disclosure.

FIG. 7B depicts a block diagram of an example computing device according to example embodiments of the present disclosure.

FIG. 7C depicts a block diagram of an example computing device according to example embodiments of the present disclosure.

### DETAILED DESCRIPTION

Generally, the present disclosure is directed to systems and methods that perform listwise learning to rank. The proposed training frameworks can be used to improve ranking performance in systems that benefit from better ranking of items that are recommended and shown together to a user in response to a query or request. In particular, the present disclosure provides new listwise loss functions and associated learning frameworks that can be applied to all items in a set of items potentially responsive to a request or query, which is a setting that occurs in recommendation systems, information retrieval systems, and other systems that provide items in response to a query. The proposed loss functions reduce bias in the resulting model as compared to alternative approaches. The proposed loss functions are also more computationally efficient than other alternatives such as an alternative pairwise approach. The proposed losses also balance between ranking performance and relevance prediction, giving a flexible method that can tune between the two objectives based on the importance of each of them.

### Description of Example Setting

In the context of recommendation systems, information retrieval systems, and/or other similar systems, the term “items” can refer to any object, entity, unit, file, or other element. As examples, items can include users, entities, movies, data files, websites, products, documents, resources, and/or other items or objects. Items can be identified and returned in response to a query. A query can be implicit (e.g., defined based on context) and/or explicit (e.g., defined based on specific natural language and/or image input (e.g., input by a user)). A query can be user-agnostic or user-specific. A query can include one or more modalities of data such as textual data, image data, and/or audio data.

Recommendation systems and other similar systems often train on a large number of training examples, where each training example includes items produced in a group (or set or list) in response to a given request or query. In particular, example approaches described herein can be applied to (e.g., trained on) a sequence of sets of items. However, it is convenient to describe the proposed methods for a single set of items (e.g., shown in response to a single query) from the sequence. Thus, for the sake of simplicity, the remainder of the discussion contained herein will be provided with reference to a single training example (e.g., a single set or list of items) and a subscript t, enumerating a set of items in the sequence, will be omitted.

In some implementations, a training example can include a plurality of items and a plurality of labels respectively associated with the plurality of items. As one example notation, the plurality of items can include N items with index i and let yᵢ∈{0,1} denote the true label associated with (e.g., observed for) item i.

The label for each item can indicate a level of engagement for such item. For example, the label can be a unit label that ranges from 0 to 1, where 0 indicates no engagement and 1 indicates complete engagement. In one example, a label of 0.7 can indicate a 70% probability of engagement. One type of unit label is a binary label that explicitly equals either 0 or 1.

The label can be predicted or can be based on a real-world interaction. As one example, a training example can be generated based on a user's interaction with a recommendation or information retrieval system. A user can enter a query into the system and the system can return (e.g., using some existing logic or algorithms) a set of items as a response to the query. The user can be able to engage with (e.g., select, choose, investigate, etc.) one or more (e.g., multiple) of the items in the list.

Once the user's interaction has been completed, the query and the items can be saved as a training example. A label can be assigned to each item in the training example. For example, if the user engaged with the item, then a label equal to 1 can be assigned to the item. However, if the user did not engage with the item, then a label equal to 0 can be assigned to the item. It is possible that multiple items in the set of items have labels equal to 1 (or otherwise indicating engagement). The above process is provided as one example only, different approaches can be used to generate a training example as well.

A ranking model can be trained on training examples having the structure described above. The training process can consume groups of items included in respective training examples (e.g., one group at a time), and can train on all items in the group. This disclosure uses the index t to denote the index in the training set of the t-th group, or item set. Due to huge scales in such systems (e.g., click-through-rate (CTR) and others), training usually focuses on learning (marginalized) individual engagement rates for the individual items.

### Drawbacks of Alternative Approaches

One possible approach in the above setting is to train a machine learning model to learn individual engagement rates using binary logistic regression in which cross entropy logarithmic loss is minimized in training. While such models do attribute credit to features (e.g., query features) that are common to all items that appear jointly in a list of items, learning often is restricted from being able to leverage dependencies among items in the same list beyond their common features.

In theory, with independence between marginal engagement rates of different items, and with models that are fully correctly specified, learning on engagement rates of individual items would be sufficient. However, in reality, engagement rates of different items that are co-recommended together on the same list of items are not independent, and models are never completely correctly specified, as hand-crafted features may not accurately model features that drive user engagement. Thus, while marginalized solutions of individual item engagement rates may be the best average solution for each item, they may not necessarily provide the best ranking solutions among items in a set of items grouped together as potential responses to a query.

On the other hand, methods that specifically target ranking in a set of items are better suited if relative ranking of items within a set of items (e.g., a “recommendation set”) is more important than the accuracy of the respective predictions of individual engagement rates. If both are important, training with multiple training objectives or loss functions (e.g., one for individual rates and the other for ranking) enables addressing both problems, where the relative strength of the multiple loss functions can be tuned to prefer one objective over the other.

One possible alternative approach for optimization of ranking in a set of co-recommended items includes the use of a pairwise ranking objective, where if there are nₜ items co-recommended together (e.g., included in the same set) for the t-th training query set, then a loss is defined for all nₜ*(nₜ−1)/2 pairs according to the relation between their individual labels. All these losses are summed up for the t-th query and included in the overall optimization of the ranking objective. However, pairwise ranking complexity is computationally expensive when nₜ is large, as it is quadratic in nₜ.

The pairwise loss approach attempts to learn the probability that the label of one item is better than that of the other. More specifically, one example pairwise loss defines, for a pair of items, i and j, a pairwise label in {0, 0.5, 1}. If the first item had a better label than the second, the pairwise label is 1. In the opposite case, it is 0, and if the labels are equal, a 0.5 label is used. Then, logistic regression cross entropy loss can be used with respect to the pairwise label, where logit scores sᵢ and sⱼ are learned for items i and j, respectively, and the score for the pairwise label is sᵢ−sⱼ.

However, this method cannot be combined (as is) with optimization of direct engagement rates where sᵢ and sⱼ are defined as the logits learned for the individual engagement rates because it regularizes the differences towards 0 logit accounting for equal label events. If sᵢ and sⱼ are the individual logit scores, then optimizing this pairwise approach with cross entropy over the logistic function (Sigmoid) of sᵢ−sⱼ will give a value that is not necessarily equal to the optimal individual values of sᵢ and sⱼ even if individual rates are independent and the model is correctly specified.

Using the logit difference of the individual engagement logits only on pairs with unequal labels aligns the pairwise ranking loss with the direct engagement one, and the Sigmoid of the logit difference can be seen as the conditional probability that one item has a better label than the other conditioned on the event that the items have unequal labels.

As an alternative to the pairwise approach described above, various listwise ranking losses have been proposed. However, listwise approaches proposed to date demonstrate bias in certain settings. In particular, one example Softmax-based listwise loss attempts to learn the probability that the label of an item in the list is better than the labels of all other items in the list conditioned on the event that a label of one item in the list is better than all the rest. Taking individual logits of all items in the list, the Softmax function is used to determine a probability of a “better label” to each of the items.

One way to understand this loss is to view it through the lens of conditional probability. If each of the scores sᵢ is the individual engagement logit of each of the items, then the Softmax probability is the conditional probability that an item has a positive label conditioned on the event that exactly one item has a positive label, and all other items have a negative one. This interpretation demonstrates the shortcoming of this Softmax-based formulation of a listwise loss. While it can be used in lists with one positive, using the loss in lists in which there may be multiple positives results in a biased solution.

A straightforward extension of the Softmax-based listwise loss to multiple positives would apply the loss for each positive against all other items in the list. However, this creates a bias, as items are counted multiple times, specifically negative ones. Other solutions that either change labels to fractional ones with multiple positives or importance weight loss components as function of the number of positives all have drawbacks that limit the benefits of this approach. Note also that the pairwise approach with conditional probabilities itself also adds a bias if multiple positives are present in the same set, because it counts each negative once for each positive example.

### Summary of Proposed Loss Functions

In view of the drawbacks described above, the present disclosure proposes alternative approaches for listwise learning to rank. One example approach can be viewed as a generalization of the pairwise conditional approach, but with minimal bias. This example approach also focuses on the aspect that ranking is not actually the critical issue that the loss should address, because with independence and proper specification, ranking is perfectly addressed by appropriate learning of individual rates. However, because there is no independence of engagement between items, and there is always misspecification, the key issue to address for better ranking is the interaction between the items. Thus, example losses proposed herein are designed to update the beliefs, stored in the logit scores, for each of the items to retain the dependencies between the items, rather than just the ranking.

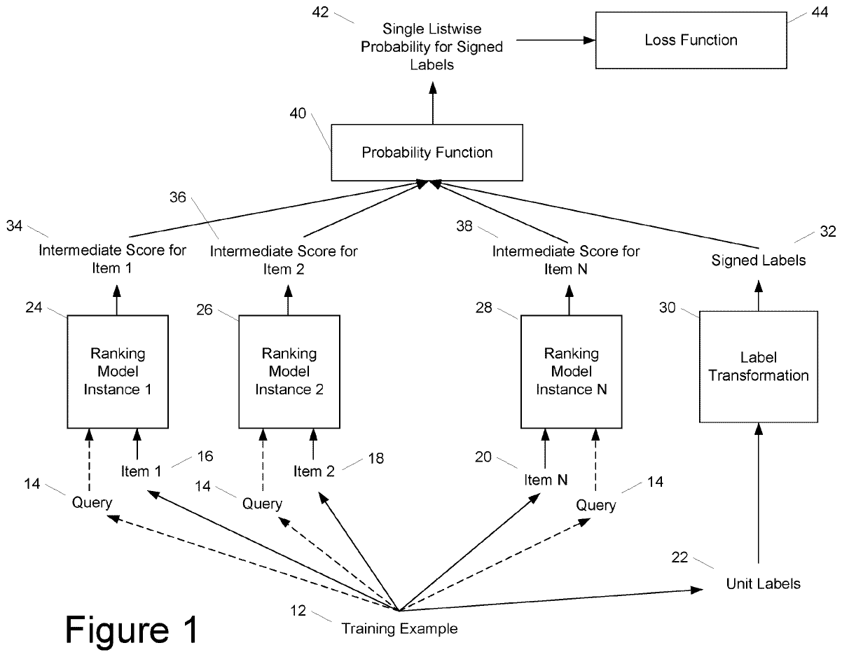

FIG. 1 depicts a diagram of an example framework to perform listwise learning to rank according to example embodiments of the present disclosure. As illustrated in FIG. 1, a computing system can obtain a training example 12. The training example 12 can include a plurality of items (e.g., items 16, 18, and 20). The training example 12 can also include a query 14. The plurality of items may be a set of items that are (or were) responsive to the query 14. The training example 12 can also include a plurality of labels associated with the plurality of items. As one example, the plurality of labels can include unit labels 22. In one example, the unit labels 22 are binary labels.

In some implementations, as shown in FIG. 1, the computing system can apply a label transformation 30 to transform the plurality of unit labels 22 into a plurality of signed labels 32. Each of the signed labels 32 can equal either positive one (1) or negative one (−1). In one example, any unit label equal to or less than some threshold value (e.g., 0 or 0.5) can be set equal to negative one, while any unit label greater than the threshold value (e.g., 0 or 0.5) can be set equal to positive one. In other examples, rather than needing to perform a label transformation 30, the training example 12 may simply include the signed labels 32.

The computing system can respectively process the plurality of items with a ranking model to respectively generate a plurality of intermediate scores respectively for the plurality of items. The query 14 can also be provided as input to the ranking model alongside each item. As examples, as illustrated in FIG. 1, item 16 can be processed by ranking model instance 24 to generate intermediate score 34; item 18 can be processed by ranking model instance 26 to generate intermediate score 36; and item 20 can be processed by ranking model instance 28 to generate intermediate score 38.

The computing system can determine a single listwise probability 42 collectively for the plurality of signed labels 32 based at least in part on the plurality of signed labels 32 and the plurality of intermediate scores (e.g., intermediate scores 34, 36, and 38). For example, the computing system can evaluate a probability function 40 that has arguments of the plurality of signed labels 32 and the plurality of intermediate scores to generate the a single listwise probability 42 collectively for the plurality of signed labels 32. Example approaches for determining the single listwise probability 42 collectively for the plurality of signed labels 32 are described in further detail in the sections that follow.

The computing system can evaluate a ranking loss function 44 based at least in part on the single listwise probability 42. Example loss functions 44 are described in further detail in the sections that follow.

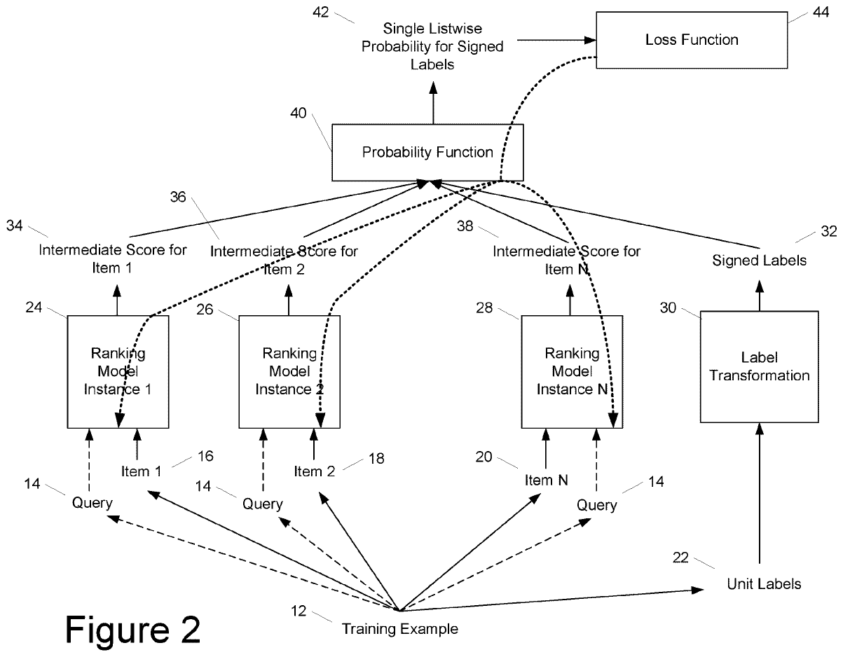

The computing system can modify one or more parameter values of the ranking model based at least in part on the ranking loss function 44. For example, as graphically illustrated in FIG. 2 through the use of a dotted line, the ranking loss function 44 can be backpropagated through some or all of the instances of the ranking model (e.g., instances 24, 26, and 28) to update parameter values of the ranking model.

Unlike the alternative Softmax-based listwise ranking loss described in the subsection above, the proposed approach is more closely geared towards the listwise framework and is minimally biased even when the list includes multiple items with positive labels. In particular, in the case in which a list includes multiple items with positive labels, the alternative softmax-based listwise loss is a very biased approximation if it is applied on the individual logit scores of the different items. However, the proposed approaches can be applied to training examples with multiple positive labels without introducing a significant bias.

Like other ranking losses (e.g., pairwise and softmax-based listwise), the proposed approach has interpretations of the ranking loss as a negative logarithm of a conditional label probability conditioned on an event. However, unlike the other approaches, this interpretation for the new loss interprets the loss conditioned on a union of conditioning events instead of just one.

The proposed method provides a loss that can be used to improve ranking that is both minimally biased and with linear complexity in the number of co-recommended items. It is minimally biased better than the pairwise loss that has O(N²) complexity, and it has O(N) complexity like the softmax listwise loss that is more biased. The proposed loss functions therefore combine the advantages of both methods and beyond.

The proposed loss functions can be used directly in training to train a ranking model. In addition or alternatively, the proposed loss functions can be used for distillation from a more complex teacher model to improve ranking of a limited deployable student model.

Thus, the proposed systems and methods provide a number of technical effects. As one example, the proposed approaches can reduce bias. Alternatively approaches introduce bias into a ranking model in settings in which a training example includes items with multiple positive labels. The proposed approaches reduce such bias and are able to capably handle the multiple-positive-label settings.

As another example technical effect, the proposed approaches can enable training of a ranking model with reduced computational expenditure. In particular, an alternative approach is a pairwise approach that generates a loss for each different pair of items in a set of items. This results in a computational expenditure that scales quadratically with the number of items in the set. In contrast, the present disclosure can generate a single listwise loss for a set of items. Therefore, the computational expenditure scales linearly with the number of items. Using the proposed approach can therefore conserve computational resources as the number of items increases, including reduced consumption of processor cycles, reduced memory usage, and/or reduced usage of network bandwidth.

### Example Discussion of Alternative Softmax-Based Approach

As described above, a training example can include a plurality of items and a plurality of labels respectively associated with the plurality of items. As one example notation, the plurality of items can include N items with index i and let yᵢ∈{0,1} denote the true label associated with (e.g., observed for) item i. Given that sᵢ is a model's belief of the logit score of the individual engagement rate of item i, the logistic (Sigmoid) function can be used to predict a probability of a positive (binary) label for example i, as

$${p}_{i} = σ ( {s}_{i} ) {=}^{Δ} \frac{1}{1 + exp ( - {s}_{i} )} .$$

A listwise ranking can assign the following ranking probability

$${p}_{i}^{ℛ} {=}^{Δ} \frac{{e}^{{s}_{i}}}{{\sum }_{j = 1}^{N} {e}^{{s}_{j}}}$$

to item i, giving, as described, a probability that the label of item i is better than the labels of other items in the set of N items. One example listwise ranking loss (e.g., contributed to the overall loss by this set of co-recommended items) is then

$${L}^{ℛ} = - {\sum }_{i = 1}^{N} {y}_{i} log {p}_{i}^{ℛ}$$

where yᵢ∈{0,1}.

Thus, the loss shown above only counts the negative logarithm of the probabilities of items with positive labels. Therefore, all item sets (or queries) with no positive labels are omitted from this loss.

Applying gradients on this loss when there are positive labeled items does affect logit scores of all items through the softmax relation. Specifically, taking steps against the gradient tends to increase logits for items with positive labels (whose gradients on the loss are negative), and decrease logits of items with zero-valued labels: Through the softmax relation, such items have contributions to the loss that increase with the logit values, and thus decreasing these logits reduces the loss.

As described above, biasing will occur if more than a single yᵢ is 1, because all items will be counted as many times as the number of positive labels in the set. Thus, queries with more positives will have more loss components included than queries with fewer positives. As such, an item with a zero-valued label showing together with more items with positive labels will have a larger multiplier on a gradient tending to reduce its logit value than a negatively labeled item showing in a query with fewer positives. This is also true for pairwise losses.

In some applications, this may be a desired “ranking” behavior, as perhaps the presence of more positives implies that a negative example in the set should be ranked lower. However, in other applications that account merely for the presence of a positive as opposed to the quantity of positives, this can create a prediction bias. Furthermore, offsetting the loss by normalization by the number of positives in the query may create an opposite bias, as now updates of positively labeled items are scaled down for the loss components that account for those positive labels.

One way to understand this alternative Softmax-based approach is to view it under a conditional interpretation in which the softmax probability defined for the listwise loss is the conditional probability of one specific item having a positive label conditioned on the event that exactly a single item has a positive label.

This is done under the assumption that the label probabilities predicted for items are independent, which is not true in practice, but is reasonable to assume under a standard logistic regression learning model, where dependences are absorbed in learned feature weights. This interpretation demonstrates why using the softmax-based loss may not be a good model in cases where multiple positive labels are expected to be observed in a given query set of items.

In particular, using this loss with the individual engagement logits sᵢ (which may be learned with a separate individual engagement loss) implies by this interpretation that this loss should only be used for sets for which only a single positive example occurs. Using it if multiple positives occur is not aligned with the definition of the logit scores, and will thus create a bias.

Recall that for logistic regression

$${e}^{{s}_{i}} = \frac{{p}_{i}}{1 - {p}_{i}} .$$

Then, the softmax probability can be seen as

$${p}_{i}^{ℛ} = \frac{{p}_{i} / ( 1 - {p}_{i} )}{{\sum }_{j = 1}^{N} {p}_{i} / ( 1 - {p}_{j} )} = \frac{{p}_{i} \cdot {\prod }_{k = 1 , k \neq i}^{N} ( 1 - {p}_{k} )}{{\sum }_{j = 1}^{N} {p}_{i} \cdot {\prod }_{\text{?} = 1 , \text{?} \neq j}^{N} ( 1 - {p}_{\text{?}} )}$$

$$\text{?} \text{indicates text missing or illegible when filed}$$

where the second equality is obtained by multiplying both numerator and denominator by the product of 1−pₖ for all k. The denominator is a sum of all disjoint events of a single item having a positive label, while all other items have a negative one. The numerator is the probability of this event with the i-th item having a positive label. Under the independence assumption, the ratio just gives the conditional probability of item i having a positive label and all other items negative ones, conditioned on the denominator describing the event of exactly a single item having a positive label.

While both the softmax listwise loss and the pairwise loss are biased when there are multiple positives by counting negatives multiple times (once for each positive), the softmax listwise loss is also misaligned with the conditional probability if more than a single positive appears in the set. This second shortcoming is not present for the pairwise loss.

### Example Improved Listwise Ranking Losses

Instead of using the alternative softmax-based approach described above, example implementations of the present disclosure extend the notion of the pairwise Sigmoid approach. As illustrated in FIG. 1, a label transformation 30 can be applied to map the unit labels yᵢ∈{0, 1} into signed labels zᵢ∈{−1, 1}, where all labels indicative of no engagement are now denoted by negative one (−1) instead of zero (0), and positive labels remain as one (1). Define the logit score S of the list of items as

$$S {=}^{Δ} {\sum }_{i = 1}^{N} {z}_{i} {s}_{i} . \qquad ( 1 a )$$

Then, one example proposed loss for the list is

$${L}^{ℛ} = I [ ∃ i > 1 : {z}_{i} \neq {z}_{\text{?}} ] \cdot log ( 1 + {e}^{- 𝒮} ) \qquad ( 1 )$$

$$\text{?} \text{indicates text missing or illegible when filed}$$

where I(.) is the indicator function, which in this case only indicates the loss is applied only if not all labels are equal. Then, the loss is the negative logarithm of the Sigmoid of the logit score S. The loss in equation (1) can be generalized by adding a hyper-parameter temperature value to

$${L}^{ℛ} = I [ ∃ i > 1 : {z}_{i} \neq {z}_{\text{?}} ] \cdot γ \cdot log ( 1 + {e}^{- 𝒮 / γ} ) . \qquad ( 1 b )$$

$$\text{?} \text{indicates text missing or illegible when filed}$$

Low temperatures of <1 regularize the score S towards 0 in logit, while temperatures larger than 1 push the difference score away from 0 logit, and the loss towards a square loss.

If the indicator function is excluded from the loss in equation (1), this objective is optimizing a transformation of the logits of a marginalized pointwise loss. For models that are fully correctly specified, this should (theoretically and asymptotically) at best give the same solution for optimal logit scores as the individual engagement pointwise loss on the individual items relative to their individual labels (the standard logistic regression cross entropy loss). However, it does lose information about the individual labels, but retains the relevance relation information (for ranking) among the items.

However, with model misspecifications, because this loss is different, it may give different results from the individual objectives. It may be able to resolve misspecifications differently, and potentially even without the indicator function, improve ranking. Using the indicator function omits the case in which all labels are equal, and pushes this loss to emphasize more on differences between items, rendering it as a ranking loss.

The example loss function in equation (1) behaves in terms of its gradients similarly to the softmax-based loss. Examples with positive labels have negative loss gradients that cause updates to increase their logits, while examples with negative labels have positive loss gradients, causing updates to decrease their logits. In fact, this is true regardless of what fraction of labels are positive and what fraction is negative, unlike the softmax loss. For the softmax loss, this property is guaranteed only if a single item has a positive label, while other items have negative ones. Otherwise, items with positive labels incur a superposition of a positive update (from the loss component of the positive label) with a negative one (from the updates of all other positive labels).

This is exactly where the loss proposed in (1) corrects the shortcomings of the softmax loss. Again, as desired of a ranking loss, the loss in (1) pushes the logits of the positives in the list up, and those of the negative ones down. Because it connects between the different logits, the loss in (1) does emphasize on relations and dependencies between labels of different items, thus behaving like a ranking loss and focusing the loss on the ranking relations.

Finally, using the conditional probability interpretation, the loss in (1) can be viewed as a sum or superposition of losses which are negative logarithms of conditional probabilities over a set of disjoint conditioning events. Each conditioning event is partitioned into two conditional events with opposite binary labels. Let Z=(z₁, . . . , z_{N}) define the label sequence for the set of N items. Then, a conditioning event consists of the pair {Z,−Z}, and the conditional probabilities used for the loss are Pr(Z|{Z,−Z}) and Pr(−Z|{Z,−Z})=1−Pr(Z|{Z,−Z}), where the probabilities are predicted by the parameters learned by the model. For one label vector in the pair, the “label” is positive, and for the other, it is negative. In fact, the all 1 vector Z can be included in the loss, but some implementations can exclude this vector to emphasize label differences.

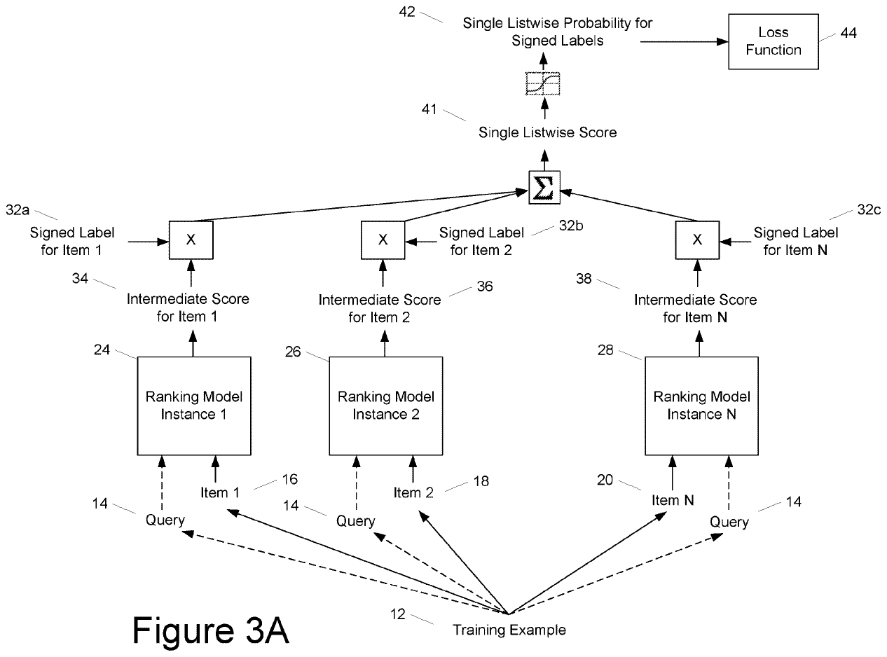

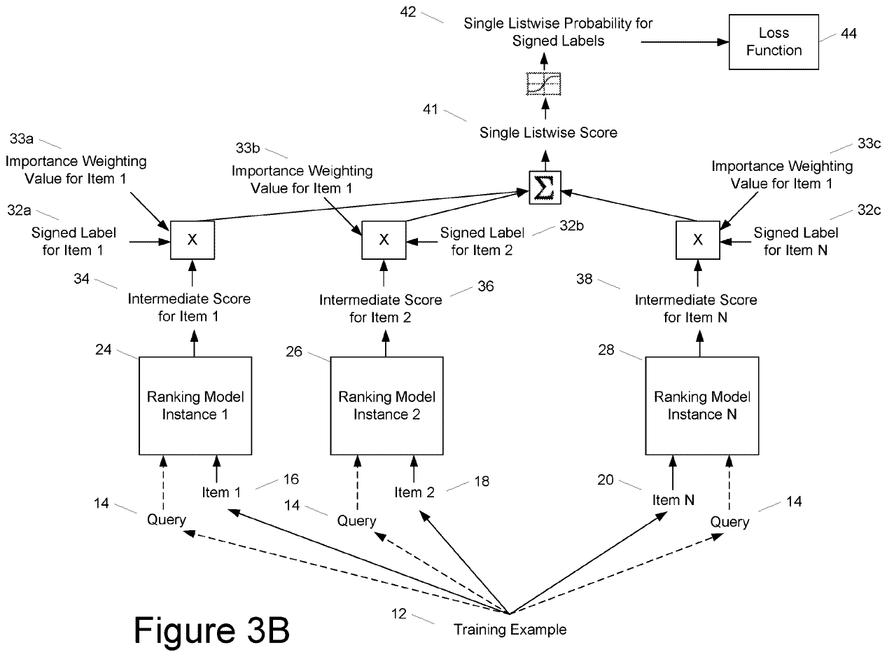

An example of the approach described in this subsection is illustrated in FIG. 3. As illustrated in FIG. 3, a set of intermediate scores 34, 36, and 38 (e.g., which can be thought of as logit values or similar) have been respectively generated by a ranking model for a set of items 16, 18, and 20. The intermediate score for each item can be multiplied by the respective signed label for such item. For example, intermediate score 34 for item 16 can be multiplied by the signed label 32a for item 16; intermediate score 36 for item 18 can be multiplied by the signed label 32b for item 18; and intermediate score 38 for item 20 can be multiplied by the signed label 32c for item 20.

The resulting values can then be summed to generate a single listwise score 41. A sigmoid function can be applied to the single listwise score 41 to generate the single listwise probability 42 for the signed labels. The single listwise probability 42 can then be evaluated using a loss function 44. For example, the loss function 44 may take the form of equation (1) or its variants described herein.

### Example Applications to Model Distillation

Distillation has become very popular in deep learning. To save on training resources, and comply with system constraints, a (typically more simple) student model can be trained from a (typically more complex) teacher model and then the student can be deployed. For example, the student model avoids complexity and may be restricted by deployment and system limitations. To speed training and also due to other system limitations, the student may also train on fewer training examples. To close the accuracy gap, a rich teacher model that is not limited by the deployment constraints of the student model can be trained (possibly once for multiple students) on a much larger training dataset, and its predictions are used to train the student model, allowing for faster training and model convergence for the student. The student can train on both the teacher's predictions (or scores) and the true labels, or only on the former, depending on system constraints and other considerations.

The example ranking loss function proposed in (1) can be adapted to ranking distillation (which can be performed on its own, or together with distillation of individual engagement rates). For ranking distillation, instead of distilling individual engagement scores or predictions, pairwise score differences have been distilled. For L2 ranking distillation, square loss can be used to distill these differences. Other losses, such as L1, quantile regression based, Huber and more can also be used. The softmax loss can also be used for distillation where the labels yᵢ are replaced by the teacher's prediction probabilities of these labels. (Note, however, that this approach also may incur the biases described for the softmax loss).

With the new listwise ranking losses proposed herein, instead of distilling pairwise scores, one can distill the query score S which is computed relative to the true signed label vector Z. Using the true vector Z, the score can be computed for both the teacher Sₜ and the student Sₛ as follows:

$${S}_{\text{?}} {=}^{Δ} {\sum }_{i = 1}^{N} {z}_{i} {t}_{i} , {S}_{\text{?}} {=}^{Δ} {\sum }_{i = 1}^{N} {z}_{i} {\text{?}}_{i}$$

$$\text{?} \text{indicates text missing or illegible when filed}$$

where sᵢ are the student's logits and tᵢ are the teacher's.

Then distilling Sₜ to Sₛ will encourage the student to follow the optimization of the listwise loss according to (1) in the teacher. The teacher can first be trained with the loss of equation (1). Then, distillation from Sₜ to Sₛ can be done with any loss trying to match the two per-query (e.g., per item set).

This can be done with L2 square loss between Sₜ and Sₛ, L1 loss, or Huber loss. Even Quantile Regression loss can be learned on this signal, although it is likely simpler to use one of the other choices. L2 loss may converge fast, but will optimize towards the logit mean. L1 loss will optimize toward the median, and Huber loss can find a minimum between the two. For the loss here this, however, applies to the statistics of Sₛ, which may be very different from those of a single example (as in distillation of direct engagement scores), and may vary also depending on the typical number N of co-recommended items.

As with the loss in (1), distillation can be applied including or excluding training examples in which all labels are equal, potentially better encouraging label differences by excluding such sets.

An alternative approach can define a query label for the teacher as the probability induced for the set and use cross entropy to distill that label to the student. An example ranking distillation (RD) loss is then given by

$${L}^{ℛ𝒟} = I [ ∃ i > 1 : {z}_{i} \neq {z}_{\text{?}} ] \cdot \{ \frac{1}{1 + {e}^{- {S}_{\text{?}}}} \cdot log [ 1 + {e}^{- {S}_{\text{?}}} ] + \frac{1}{1 + {e}^{- {S}_{\text{?}}}} \cdot log [ 1 + {e}^{- {S}_{\text{?}}} ] \} \qquad ( 1 c )$$

$$\text{?} \text{indicates text missing or illegible when filed}$$

where, in some implementations, distillation is applied only if not all (true) labels are equal. Note that the logistic loss is applied here on both a positive and negative “probability” translation of Sₜ to give a gradient that is the difference between the student's and the teacher's probability interpretation of the scores Sₛ and Sₜ. The indicator function can be removed to apply distillation on every training example. A temperature hyper-parameter can also optionally be added to generalize the distillation loss, giving

$${L}^{ℛ𝒟} = I [ ∃ i > 1 : {z}_{i} \neq {z}_{1} ] \cdot \{ \frac{γ}{1 + {e}^{- {S}_{\text{?}} / γ}} \cdot log [ 1 + {e}^{- {S}_{\text{?}} / γ} ] + \frac{γ}{1 + {e}^{- {S}_{\text{?}} / γ}} \cdot log [ 1 + {e}^{- {S}_{\text{?}} / γ} ] \} . \qquad ( 1 d )$$

$$\text{?} \text{indicates text missing or illegible when filed}$$

A potential advantage to distilling listwise scores over pairwise is that the statistics for which the loss is optimizing is computed in the pairwise case such that it is marginalized on the position of the items in the list (unless the model has position features to capture these effects). A pair of positive and negative labels is the same regardless of in which positions the two items occur.

The listwise loss proposed here does not lose the position information and may benefit from that. Furthermore, unlike pairwise loss and softmax listwise loss, it does not have the learning bias that overcounts negatives when there are multiple positives. The use of the vector Z also for distillation ensures that such a bias is not introduced.

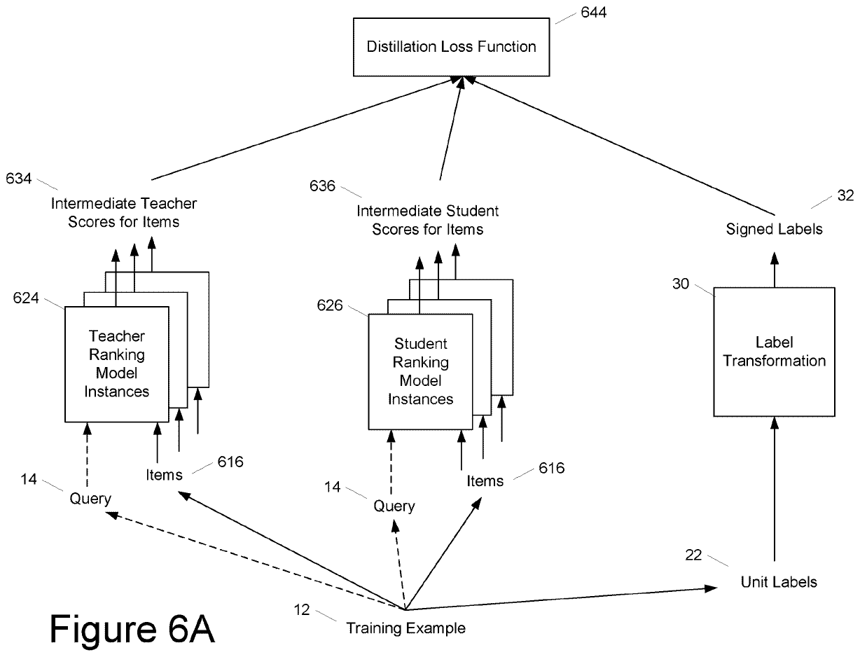

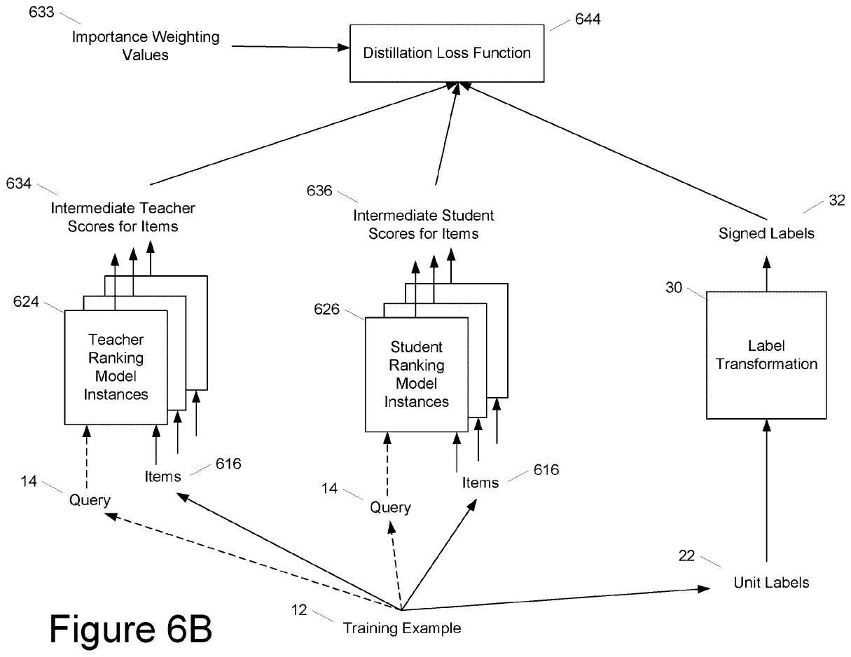

FIG. 6A depicts an example illustration of an example distillation approach as described in this subsection. In particular, a computing system can obtain a training example 12 that includes a plurality of items 616 and a plurality of signed labels 32 respectively associated with the plurality of items 616.

The computing system can respectively process the plurality of items 616 with respective instances a teacher ranking model 624 to respectively generate a plurality of intermediate teacher scores 634 respectively for the plurality of items 616. Likewise, the computing system can respectively process the plurality of items 616 with a respective instances of a student ranking model 626 to respectively generate a plurality of intermediate student scores 636 respectively for the plurality of items 616.

The computing system can evaluate a distillation loss function based at least in part on the plurality of signed labels 32, the plurality of intermediate teacher scores 634, and the plurality of intermediate student scores 636. The computing system can modify one or more parameter values of at least the student ranking model 626 based at least in part on the distillation loss function 644. For example, the distillation loss function 644 can be backpropagated through the student ranking model 626.

As one example, the distillation loss function 644 can be an L2 square loss, L1 loss, or Huber loss between Sₜ and Sₛ, as described herein. As other examples, the distillation loss function 644 can be the distillation loss functions described in equations (1c) or (1d), or variants thereof.

### Example Probabilistic View

Direct (pointwise) engagement losses marginalize predictions on individual rates over all other co-recommended items in a set of items. Pairwise ranking losses as well as softmax listwise ranking losses focus on conditional probabilities conditioned on events with unequal labels. In both cases of pointwise and ranking losses, a suboptimal approximation of the joint distribution is obtained. In the former, a marginalized one, which implicitly assumes independence between engagement rates of different items, in the latter a conditional one.

To model the complete interactions, a loss framework would ideally model the full joint probability. This is not feasible in large scales with multiple items. Thus, to optimize for engagement rates, certain approaches approximate independence, focusing on marginals. On the other hand, to optimize for ranking, certain approaches focus on the conditional.

Example listwise losses proposed herein attempt to focus as closely as possible on the joint probability, which attempts to model the complete interaction between the different items. If the loss framework drops sets where all items have equal labels, the framework can skew toward focusing on the full interactions conditioning on events in which items can be ranked. This does bias predictions of individual rates, but focuses on the ranking goals. Thus, because this approach only drops events where all labels are equal, individual predictions, like any ranking loss, will be only slightly biased, but are likely to not be as highly biased as other ranking losses.

Further, unlike other ranking losses (e.g., softmax-based listwise and pairwise), the proposed approaches do not introduce counting biases that result from applying an unequal number of multiple losses on negatives that co-occur with multiple positives. Specifically, a query with more positives will apply more loss components on its negative examples than a query with fewer positives for both pairwise and softmax listwise losses. This will not be the case with the proposed loss.

### Example Extended Softmax Listwise Loss

The approach in equation (1) assigns a single ranking score to the set of items, which is then used to generate a single probability representing the set of labels observed for the set of items. As examples, the probability can be the Sigmoid (logistic) function of the score, and the loss can be the negative logarithm of the probability.

An approach with a similar flavor that assigns a single Softmax probability to the set of labels can extend the Softmax-based loss described above. Note that the Softmax loss assigns a probability to the set of labels only when the set consists of exactly one positive label, and all other labels are negative. Otherwise, as many losses as the number of positive labels are applied. An extended loss described in this subsection will apply a single loss over a single assigned probability for any number of positives.

Recall the signed label notation of zᵢ∈{−1, 1}, where 1 describes a positive label and −1 a negative one, and that sᵢ are the logit scores of the items in the set. For a set of labels {y₁, y₂, . . . , y_{N}}, which can be mapped into {z₁, z₂, . . . , z_{N}}, define the extended Softmax probability proposed herein as

$${p}^{ℛ} ( {z}_{1} , {z}_{2} , … , {z}_{N} ) {=}^{Δ} \frac{1}{1 + {\sum }_{\text{?}} {e}^{\text{?}} + {\sum }_{\text{?}} {e}^{\text{?}}} = \frac{1}{1 + {\sum }_{j = 1}^{N} {e}^{\text{?}}} \qquad ( 2 )$$

$$\text{?} \text{indicates text missing or illegible when filed}$$

Then, the ranking loss component for this item set can be given by

$${L}^{ℛ} = - log {p}^{ℛ} ( {z}_{1} , {z}_{2} , … , {z}_{N} ) = log [ 1 + {\sum }_{j = 1}^{N} {e}^{\text{?}} ] . \qquad ( 3 )$$

$$\text{?} \text{indicates text missing or illegible when filed}$$

It is easily verified that negative gradients on the loss in (3) push the logits of items with a positive label to increase, and those of items with negative labels to decrease, which is what is expected from a ranking loss. Furthermore, the loss can be applied once for the set of examples, yet, applying updates in correct directions independently of the number of positives in the set. As in equation (1), an indicator function can be added that applies the loss only when at least two labels are not equal

$${L}^{ℛ} = - log {p}^{ℛ} ( {z}_{1} , {z}_{2} , … , {z}_{N} ) = I ( ∃ i : {z}_{i} \neq {z}_{\text{?}} ) \cdot log [ 1 + {\sum }_{j = 1}^{N} {e}^{\text{?}} ] . \qquad ( 4 )$$

$$\text{?} \text{indicates text missing or illegible when filed}$$

Further, as in equation (1b), the loss can be generalized to include a temperature hyper-parameter

$${L}^{ℛ} = - log {p}^{ℛ} ( {z}_{1} , {z}_{2} , … , {z}_{N} ) = I ( ∃ i : {z}_{i} \neq {z}_{\text{?}} ) \cdot γ \cdot log [ 1 + {\sum }_{j = 1}^{N} {e}^{\text{?}} ] \qquad ( 4 a )$$

$$\text{?} \text{indicates text missing or illegible when filed}$$

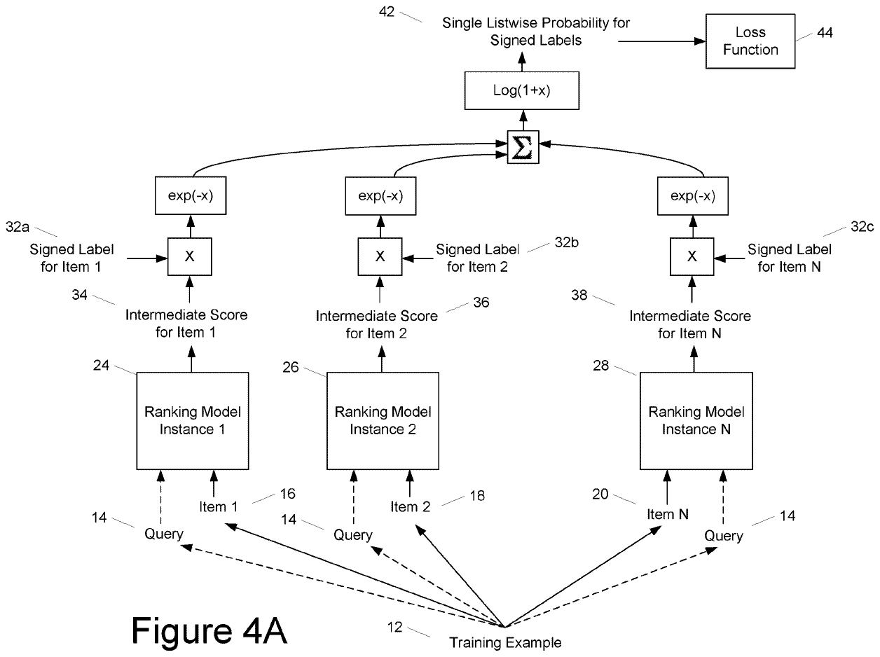

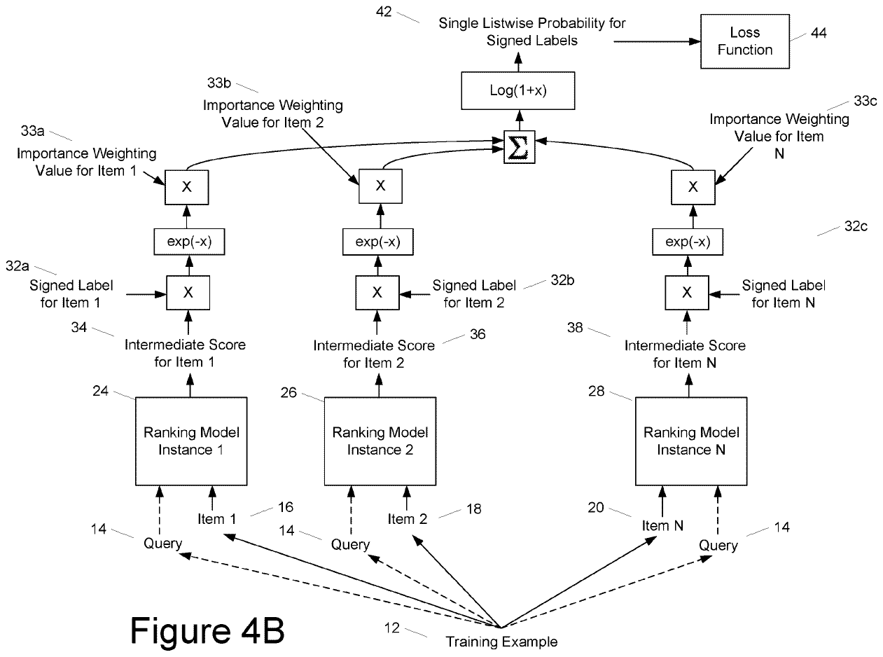

An example illustration of this approach is shown in FIG. 4A. Similar to the approach in FIGS. 1, 2, and 3A, in FIG. 4A, a set of intermediate scores 34, 36, and 38 can be generated for a set of items 16, 18, 20. Again, similar to the approach in FIG. 3A, in FIG. 4A, the intermediate score for each item can be multiplied by the respective signed label for such item. For example, intermediate score 36 for item 16 can be multiplied by the signed label 32a for item 16; intermediate score 36 for item 18 can be multiplied by the signed label 32b for item 18; and intermediate score 38 for item 20 can be multiplied by the signed label 32c for item 20.

In FIG. 3A the resulting values of the multiplications were summed. However, in FIG. 4A, the computing system can determine an exponential function of a negative of the resulting value of the multiplication of each signed label with the corresponding intermediate score. A summation can then be applied to the results of the exponential functions. Next, a logarithm of one plus the sum can be determined to generate the single listwise probability 42 for the signed labels.

Thus, the extended Softmax listwise loss in equation (4) resembles the listwise loss in equation (1). The difference between the two is that the loss in (1) uses an exponent of a sum inside the logarithm, whereas the loss in (4) uses a sum of exponents, where the arguments in both cases are the label sign weighted logits. The gradients of both losses with respect to the logits are given by

$$\frac{\partial {L}_{Sigmoid}^{ℛ}}{\partial {s}_{i}} = \frac{- {z}_{i} \cdot exp ( - {\sum }_{j} {z}_{j} {s}_{j} )}{1 + exp ( - {\sum }_{ℓ} {z}_{ℓ} {s}_{ℓ} )} = \frac{- {z}_{i}}{1 + exp ( {\sum }_{j} {z}_{j} {s}_{j} )}$$

$$and$$

$$\frac{\partial {L}_{Softmax}^{ℛ}}{\partial {s}_{i}} = \frac{- {z}_{i} \cdot exp ( - {z}_{i} {s}_{i} )}{1 + {\sum }_{j} {e}^{- {z}_{j} {s}_{j}}} .$$

The Sigmoid driven loss has a gradient whose magnitude is equal to all items in the list, whereas the magnitude of the extended Softmax loss varies among the items. Specifically, if one item has a very large logit in the direction that matches the label, it will give a large negative argument in the exponent for that item in the Softmax loss, but may give similar behavior to the exponent of all items for the Sigmoid loss.

This will lead to very small gradients and updates to all items in the list for the loss of (1), but only the item correctly ranked for the loss in (4). This behavior implies some advantage to using the loss in (4), that may be able to correct rankings for items that are not ranked correctly with respect to a given example, even if there are items that are already ordered properly with large ordering scores.

The loss in (1) may be much slower to correct such cases, as the large correct scores of items correctly ordered may dilute the updates of other items. Note, however, that this will happen only if the incorrectly ordered items have rather moderate scores that are unable to offset the large score of the highly correctly ranked item. On the other hand, a single incorrectly ranked item, for which the label and the score have opposite signs, can substantially increase the denominator of the gradient for the loss in (4), essentially blocking updates for other more moderately incorrectly ranked items, where only the largely incorrectly ordered item obtains a non-negligible gradient.

To better understand the extended Softmax loss, this section will now demonstrate the relationship between the probability in equation (2) and the individual pointwise probabilities predicted for the items in the list. Let pᵢ denote those individual probabilities, where pᵢ=1/(1+e^{\hat{ }{-s}ᵢ}). Then,

$$\frac{1}{1 + {\sum }_{\text{?}} {e}^{\text{?}} + {\sum }_{\text{?}} {e}^{\text{?}}} = \frac{1}{1 + {\sum }_{\text{?}} \frac{\text{?}}{\text{?}} {\sum }_{m} \frac{1 - \text{?}}{\text{?}}} = \frac{{\prod }_{j} ( 1 - {p}_{j} ) \cdot {\prod }_{m} {p}_{m}}{\begin{matrix}{\prod }_{j} ( 1 - {p}_{j} ) \cdot {\prod }_{m} {p}_{m} + {\sum }_{\text{?}} {p}_{j} \cdot {\prod }_{\text{?}} ( 1 - {p}_{\text{?}} ) \cdot \\ {\prod }_{\text{?}} {p}_{\text{?}} + {\sum }_{\text{?}} ( 1 - {p}_{\text{?}} ) \cdot {\prod }_{\text{?}} {p}_{\text{?}} \cdot {\prod }_{\text{?}} ( 1 - {p}_{\text{?}} )\end{matrix}}$$

$$\text{?} \text{indicates text missing or illegible when filed}$$

The second equality can be obtained by multiplying both numerator and denominator by the products of (1−pⱼ) for negative labels, and by pₘ for positive labels. Observing the equation above, the odds ratio of the probability in equation (2) is

$$\frac{{p}^{ℛ}}{1 - {p}^{ℛ}} = \frac{{\prod }_{j} ( 1 - {p}_{j} ) \cdot {\prod }_{m} {p}_{m}}{\begin{matrix}{\sum }_{\text{?}} {p}_{\text{?}} \cdot {\prod }_{\text{?}} ( 1 - {p}_{\text{?}} ) \cdot {\prod }_{\text{?}} {p}_{\text{?}} + \\ {\sum }_{\text{?}} ( 1 - {p}_{m} ) \cdot {\prod }_{\text{?}} {p}_{\text{?}} \cdot {\prod }_{\text{?}} ( I - {p}_{\text{?}} )\end{matrix}}$$

$$\text{?} \text{indicates text missing or illegible when filed}$$

This implies that the conditional probability predicted by p^{R} is that for which the respective odds are between the predictions of the event describing the true labels of all items in the set and the event that is the union of all N events for which a label of a different item in the list is flipped where all other labels are kept constant. This conditional probability is one of a ranking loss, which measures some aggregate effect relative to an event in which any of the labels are flipped. The probability p^{R} is the conditional probability of the observed label sequence conditioned on the event that that label sequence is observed or any label sequence which differs from the observed label sequence by one label is observed.

As with the Sigmoid based listwise ranking loss, some example implementations can also apply the extended Softmax loss in a distillation setting. One approach is to use a listwise version of ranking distillation (with square loss) to distill teacher logit differences (where teacher logits are denoted as tᵢ) to the student logit differences. Another approach is to use any loss (such as L2) to distill the sum of exponents score which is used inside the logarithm in equation (3) from the teacher to the student. However, some example implementations can also use cross entropy loss to directly distill a predicted teacher prediction label to the student prediction p^{R}. The teacher label aggregated on all examples in the list is given (similarly to equation (2)) by

$${p}^{ℛ ( t )} ( {z}_{1} , {z}_{2} , … , {z}_{N} ) = \frac{1}{1 + {\sum }_{j = 1}^{N} {e}^{\text{?}}} \qquad ( 5 )$$

$$\text{?} \text{indicates text missing or illegible when filed}$$

and a Softmax distillation loss

$$\begin{matrix}{L}^{ℛ𝒟} = {p}^{\text{?}} \cdot log {p}^{\text{?}} ( {z}_{1} , {z}_{2} , … , {z}_{N} ) - [ 1 - {p}^{\text{?}} ] \cdot \\ log [ 1 - {p}^{\text{?}} ( {z}_{1} , {z}_{2} , … , {z}_{N} ) ] \\ = {p}^{\text{?}} \cdot log [ 1 + {\sum }_{j = 1}^{N} {e}^{\text{?}} ] + [ 1 - {p}^{\text{?}} ] \cdot \\ \{ log [ 1 + {\sum }_{j = 1}^{N} {e}^{\text{?}} ] - log [ {\sum }_{\text{?}}^{N} {e}^{\text{?}} ] \} \\ = log [ 1 + {\sum }_{j = 1}^{N} {e}^{\text{?}} ] - [ 1 - {p}^{\text{?}} ] \cdot log [ {\sum }_{j = 1}^{N} {e}^{\text{?}} ]\end{matrix} \qquad ( 6 )$$

$$\text{?} \text{indicates text missing or illegible when filed}$$

is applied to update the logits sᵢ with the teacher list label, where RD stands for Ranking Distillation. As in equation (1d), this approach can be generalized to include a tunable temperature hyper-parameter. The full loss can be aggregated over all sets of items.

### Example Extension of the Pairwise Loss to Listwise

Taking a conditional view of the pairwise ranking loss, the logit difference sᵢ−sⱼ for a pair of items i and j is

$${s}_{ij} = {s}_{i} - {s}_{j} = log \frac{{p}_{i} ( 1 - {p}_{j} )}{{p}_{j} ( 1 - {p}_{i} )} .$$

This is only true by (incorrectly, but approximately) assuming independence between the individual predictions of the two items. This can be taken a step further by (approximately) assuming independence among all exp(sᵢⱼ) for all pairs included in the pairwise loss from the list of pairs. Let N₋ denote the number of negative labels in the item set, and N₊ the number of positive labels in the set (N₋+N₊=N). This produces a new listwise score

$$S = log \{ {\prod }_{{i = 1}_{{y}_{\text{?}} = 1}}^{N} {\prod }_{{j = 1}_{{y}_{\text{?}} = 0}}^{N} \frac{{p}_{i} \cdot ( 1 - {p}_{j} )}{( 1 - {p}_{i} ) \cdot {p}_{j}} \} = {\sum }_{{i = 1}_{{y}_{\text{?}} = 1}}^{N} \cdot {\sum }_{{j = 1}_{{y}_{\text{?}} = 0}}^{N} ( {s}_{i} - {s}_{j} ) = {N}_{-} \cdot {\sum }_{{i = 1}_{{y}_{\text{?}} = 1}}^{N} {s}_{i} - {N}_{+} \cdot {\sum }_{{i = 1}_{{y}_{\text{?}} = 0}}^{N} {s}_{i} \qquad ( 7 )$$

$$\text{?} \text{indicates text missing or illegible when filed}$$

The score in equation (7) counts the logit of every positive as many times as the number of negative labels, and the logit of every negative as the number of positive labels. These are equal to the number of times the pairwise loss is applied on each of the logits. Instead of using the pairwise loss, which requires O(N²) operations, the score S can be computed with O(N) operations, counting the positives and negatives, and then computing the score for each item i using these counts.

Then, a single loss can be applied using, e.g., equation (1) (or (1b) with temperature) with the new score S. The overall process (including backpropagating loss gradients to the networks of each item) takes O(N) operations instead of O(N²) operations. However, loss gradients are applied with an equal weight to the pairwise loss. On the other hand, though, like the difference between the loss in equation (4) and that in equation (1), the gradients with the score of equation (7) will be of equal magnitude for all positives and for all negatives, whereas the gradients of the pairwise loss will have magnitudes that depend on the pair logits.

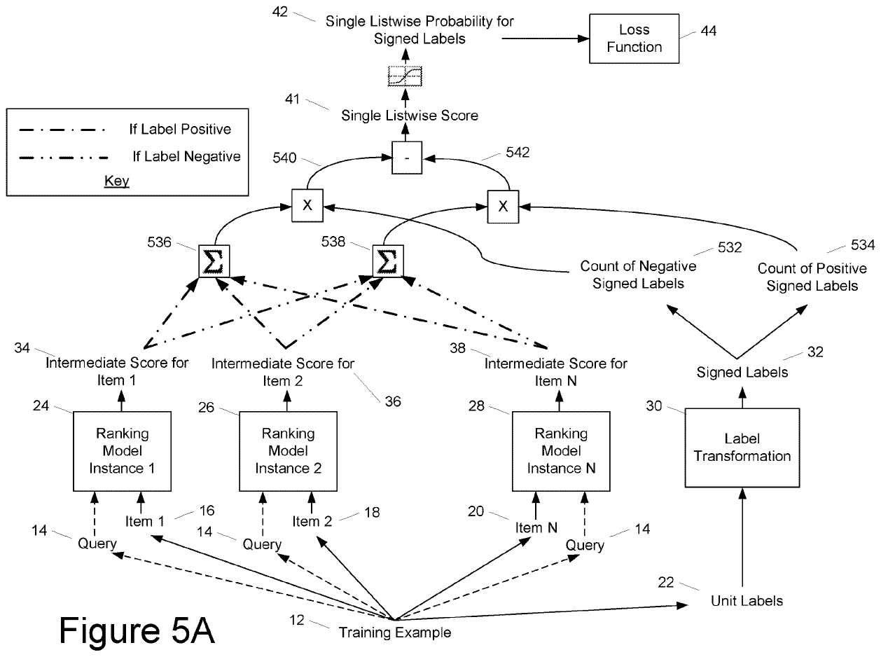

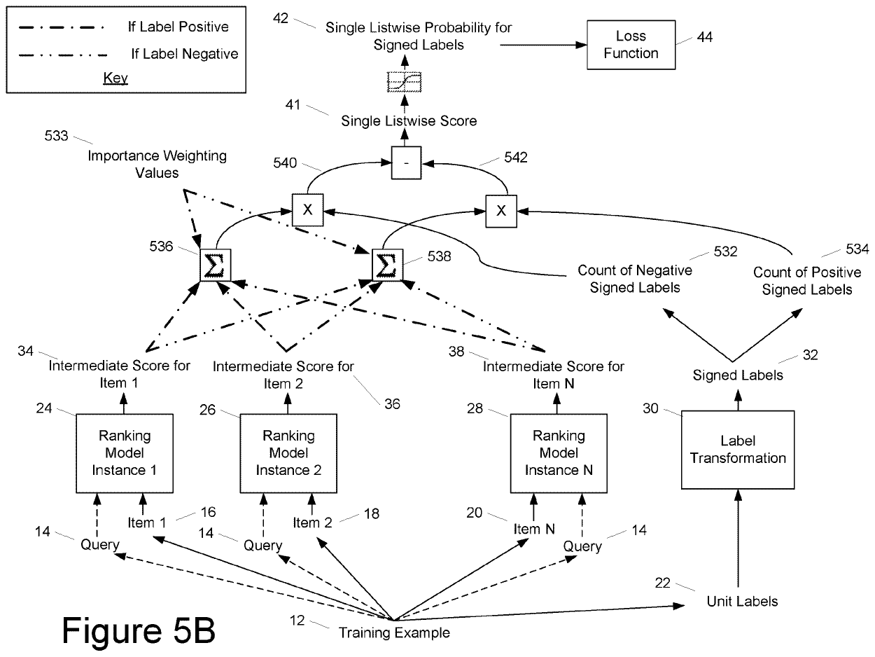

An example of this approach is illustrated in FIG. 5A. As illustrated in FIG. 5A, and similar to the approaches described above, respective instances of a ranking model 24, 26, and 28 can respectively process a set of items 16, 18, and 20 to respectively generate a plurality of intermediate scores 34, 36, and 38. The computing system can also generate or otherwise obtain a plurality of signed labels 32.

However, unlike the approaches described above, in the approach shown in FIG. 5A, a computing system can generate a count 532 of the negative signed labels in the plurality of signed labels 32. Likewise, the computing system can generate a count 534 of positive signed labels in the plurality of signed labels 32. Various different types of counts are possible, as described further below. One example type of count is a raw count. In a raw count, let N₋ denote the count 532 of the negative signed labels, and N₊ the count 534 of positive signed labels (N₋+N₊=N).

As illustrated in FIG. 5A using single and double dotted lines to demonstrate conditional data flow, the computing system can generate a first sum 536 of the intermediate scores associated with items that have signed labels that are positive valued; and a second sum 538 of the intermediate scores associated with items that have signed labels that are negative valued.

The computing system can then determine a first value 540 that equals the count 532 of the signed labels that are negative valued multiplied by the first sum 536 of the intermediate scores associated with items that have signed labels that are positive valued. Likewise, the computing system can determine a second value 542 that equals the count 534 of the signed labels that are positive valued multiplied by the second sum 538 of the intermediates scores associated with items that have signed labels that are positive valued.

The computing system can then generate a single listwise score 41 from the first value 540 and the second value 542. For example, the single listwise score 41 can equal the first value minus the second value. A single listwise probability 42 for the signed labels 32 can be determined from the single listwise score 41. For example, a sigmoid function can be applied to the score 41 to generate the probability 42. A loss function 44 can be used to evaluate the probability 42. For example, the loss function 44 can be any of the loss functions described herein.

In some implementations, to offset the independence assumption between different pairs, the probability ratio exp(sᵢⱼ) can be exponentiated with some hyperparameter 0:0<v<1, overall scaling the score in equation (7) by v. In this case, the counts 532 and 534 can be referred to as scaled counts. For scaled counts, let v₁N₋ denote the count 532 of the negative signed labels, and v₂N₊ the count 534 of positive signed labels (N₋+N₊=N).

Additionally or alternatively, to prevent extreme values, the score S can be normalized by N. In this case, the counts 532 and 534 can be referred to as normalized counts. For normalized counts, let

$$\frac{{N}_{-}}{N}$$

denote the count 332 of the negative signed labels, and

$$\frac{{N}_{+}}{N}$$

the count 534 of positive signed labels (N₋+N₊=N).

Additionally or alternatively, the score S can be normalized by N and also exponentiating the resulting coefficients with hyperparameters α and β, giving

$$S = {( \frac{{N}_{-}}{N} )}^{α} \cdot {ν}_{1} \cdot {\sum }_{{i = 1}_{{y}_{\text{?}} = 1}}^{N} {\text{?}}_{i} = {( \frac{{N}_{+}}{N} )}^{α} \cdot {ν}_{2} \cdot {\sum }_{{j = 1}_{{y}_{\text{?}} = 0}}^{N} {\text{?}}_{j} \qquad ( 8 )$$

$$\text{?} \text{indicates text missing or illegible when filed}$$

where the exponent here was also separated for positives and negatives. Alternatively, normalization by N can be omitted, giving

$$S = {N}_{-}^{α} \cdot {ν}_{1} \cdot {\sum }_{{i = 1}_{{y}_{\text{?}} = 1}}^{N} {s}_{i} - {N}_{+}^{β} \cdot {ν}_{2} \cdot {\sum }_{{j = 1}_{{y}_{\text{?}} = 0}}^{N} {s}_{j} . \qquad ( 9 )$$

$$\text{?} \text{indicates text missing or illegible when filed}$$

In this case, the counts 532 and 534 can be referred to as exponentiated counts. For normalized counts, let

$${N}_{-}^{α}$$

denote the count 532 of the negative signed labels, and

$${N}_{+}^{β}$$

the count 534 of positive signed labels (N₋+N₊=N). Any combination of scaling, normalization, and/or exponentiation of the counts 532 and 534 can be used.

The exponents α and β can be justified from the lack of real independence (potentially replacing the parameters). If α=β=0 and v₁=v₂=1, the score simplifies to the simple case score in equation (1a) preceding equation (1). Thus the first listwise score in equation (1a) is a special case of the score in (8).

In some applications, ranking may change with more positive examples, while in others, the number of positives in the set should not affect the ranking. The loss in equation (1) with the score in (7) or the score in (8) or (9) (with α=β=1 or with other nonzero values) may be better in the latter setting, but—unlike the pairwise loss—can be computed in linear complexity. Further, unlike the original Softmax loss, the loss in (1) with the scores in (7), (8) or (9) is matched with the logits learned for individual engagement rates. On the other hand, in applications where the number of positives should not affect ranking, using the loss in (1) with the score in (1a) or the score in (8) with α=β=1 and v₁=v₂=1 or the loss in (4) may be more beneficial.

There are different normalization and scaling forms that the score in (8) can take. For example, normalization by N can be taken out of the exponent, or can have its own hyperparameter, allowing also for 0 exponent as in (9), which gives the ability to downscale the positive and negative counts, independently of the total count.

The scaling of the scores in (7), (8) or (9) can also be applied to the loss in equation (4). Instead of summing over logits with additional scaling and taking the exponent of the negative sum, we can sum negative exponents of the logits, scaling the negative exponent components of the sum as in equation (7), (8) or (9), and then apply the logarithmic loss on this sum plus 1. This would give a generalization of the extended Softmax loss, which following equation (7) gives

$${L}^{ℛ} = I ( ∃ i : {z}_{i} \neq {z}_{\text{?}} ) \cdot log [ 1 + {N}_{-} \cdot {\sum }_{{j = 1}_{{y}_{\text{?}} = 0}}^{N} {e}^{\text{?}} + {N}_{+} \cdot {\sum }_{{j = 1}_{{y}_{\text{?}} = 0}}^{N} {e}^{\text{?}} ] . \qquad ( 10 )$$

$$\text{?} \text{indicates text missing or illegible when filed}$$

Similarly, losses can be derived for equations (8) and (9).

### Example Importance Weighting and Training Sampling

Some recommendation systems train on sampled examples from the population, where for different population slices, sampling rates are different. In huge scale systems where the probability of a positive label is relatively low, and there is strong imbalance between positive and negative training examples, training efficiency and training data storage efficiency can be improved by sampling the negatives instead of training over all of them.

To offset sampling rate and to train models that are unbiased when applied on the real population, importance weighting methods can be applied. Importance weighting methods up-weight training examples to offset sampling so that the fraction of sampled slices in the population are represented correctly by the model. For a training example which is sampled at some sampling rate R, its training weight can be upweighted by 1/R. This can be interpreted as if the example is counted 1/R times in the training data.

Let wᵢ denote the weight of item i in the set of N items for some query. If yᵢ=1 and yⱼ=0, the pairwise weight can be weighted by wᵢ·wⱼ to account for all pairs of wᵢ positives and wⱼ negatives represented by the two items. Such weighting enhances the counting bias already in the pairwise loss. The Softmax listwise loss would count the positive item wᵢ times, and apply the Softmax listwise loss wᵢ times, enhancing the misalignment of the loss with the logit scores.

Unlike these losses, importance weighting fits directly to the methods proposed in this document. Example weights can simply scale the respective elements in the sums that derive the different scores for the different losses.

As one example, for the Sigmoid listwise loss in equation (1), the score in equation (1a) can be modified to

$$S {=}^{Δ} {\sum }_{i = 1}^{N} {w}_{i} {z}_{i} {s}_{i} \qquad ( 11 )$$

and equations (1) or (1b) can be used similarly for the loss.

An example illustration of this modification is shown in FIG. 3B. FIG. 3B is nearly identical to FIG. 3A, with the exception that respective importance weighting values are used when generating the single listwise score 41. In particular, an importance weighting value 33a for item 16 can be multiplied with the signed label 32a for item 16 and the intermediate score 34 for item 16; an importance weighting value 33b for item 18 can be multiplied with the signed label 32b for item 18 and the intermediate score 36 for item 18; and an importance weighting value 33c for item 20 can be multiplied with the signed label 32c for item 20 and the intermediate score 38 for item 20.

Another example application of importance weighting is in the distillation setting. For example, in the distillation setting, the teacher and the student scores are modified as in equation (11), and equations (1c) or (1d) can be used for the distillation loss. An example illustration of this modification to the distillation setting is shown in FIG. 6B. FIG. 6B is nearly identical to FIG. 6A, with the exception that a set of importance weighting values 633 can be used when evaluating the distillation loss function, for example in accordance with equations (1c) or (1d) as applied to teacher and student scores modified as described in equation (11).

Another example application of importance weighting is for the extended Softmax loss. For the extended Softmax loss, equation (4) can be modified to

$${L}^{ℛ} = I ( ∃ i : {z}_{i} \neq {z}_{\text{?}} ) \cdot log [ 1 + {\sum }_{j = 1}^{N} {w}_{i} \cdot {e}^{\text{?}} ] . \qquad ( 12 )$$

$$\text{?} \text{indicates text missing or illegible when filed}$$

Equations (3) and (4a) can be modified in a similar way, as well as equations (5) and (6) for distillation.

An example illustration of this modification to the extended Softmax loss is shown in FIG. 4B. FIG. 4B is nearly identical to FIG. 4A, with the exception that respective importance weighting values are used when generating the single listwise probability 42. In particular, an importance weighting value 33a can be multiplied with a result of application of an exponential function to a negative of the signed label 32a multiplied with the intermediate score 34; an importance weighting value 33b can be multiplied with a result of application of an exponential function to a negative of the signed label 32b multiplied with the intermediate score 36; and an importance weighting value 33c can be multiplied with a result of application of an exponential function to a negative of the signed label 32c multiplied with the intermediate score 38.

For the extended pairwise loss, equation (7) can be modified to

$$S = {N}_{-} \cdot {\sum }_{{i = 1}_{{y}_{\text{?}} = 1}}^{N} {w}_{i} {s}_{i} - {N}_{+} \cdot {\sum }_{{j = 1}_{{y}_{\text{?}} = 0}}^{N} {w}_{j} {s}_{j} . \qquad ( 13 )$$

$$\text{?} \text{indicates text missing or illegible when filed}$$

Equations (8) or (9) can be modified in a similar manner. An example illustration of this modification to the extended pairwise loss is shown in FIG. 5B. FIG. 5B is nearly identical to FIG. 5A, with the exception that respective importance weighting values 533 are used when generating the first sum 536 and second sum 538, for example in accordance with equation (13).

For the generalized extended Softmax listwise loss in equation (10), a similar modification gives a loss of

$${L}^{ℛ} = I ( ∃ i : {z}_{i} \neq {z}_{\text{?}} ) \cdot log [ 1 + {N}_{-} \cdot {\sum }_{{j = 1}_{\text{?} = 1}}^{N} {w}_{\text{?}} \cdot {e}^{\text{?}} + {N}_{\text{?}} \cdot {\sum }_{{j = 1}_{\text{?} = 0}}^{N} {w}_{j} \cdot {e}^{\text{?}} ] . \qquad ( 14 )$$

$$\text{?} \text{indicates text missing or illegible when filed}$$

### Example Devices and Systems

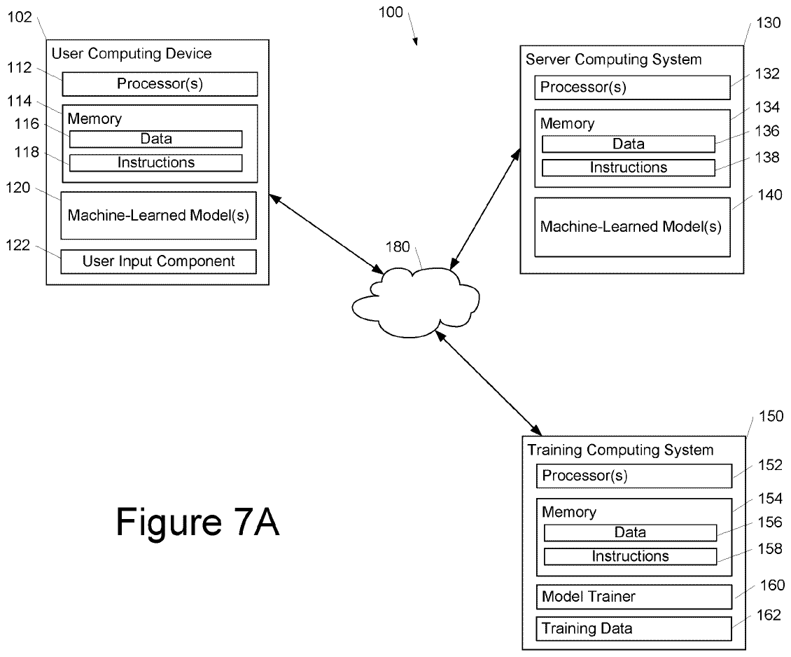

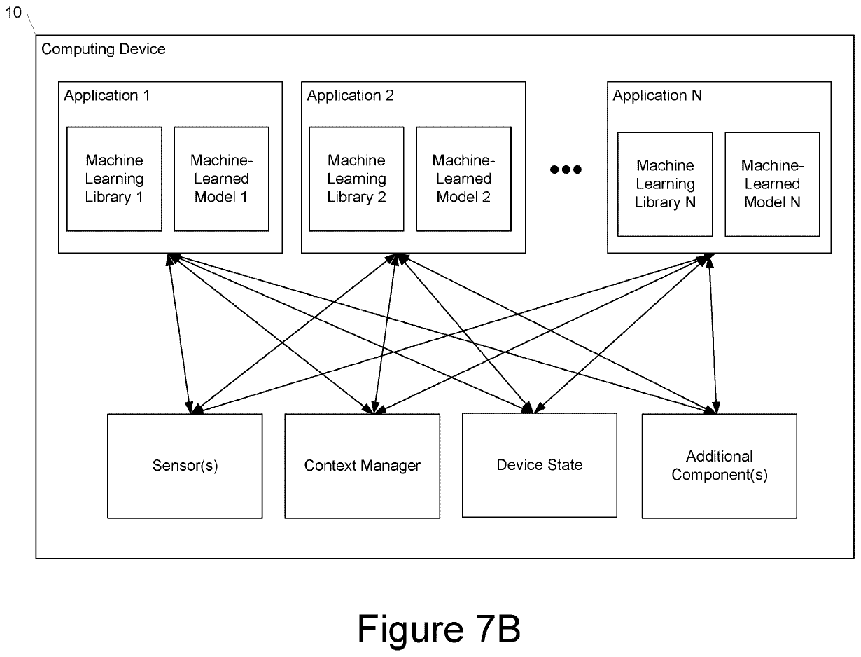

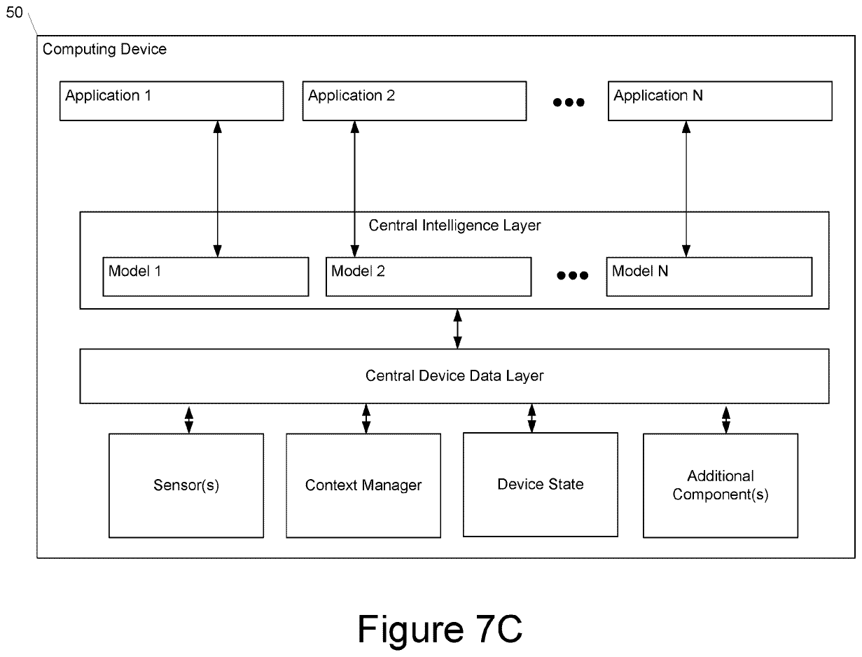

FIG. 7A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned ranking models 120. For example, the machine-learned ranking models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned ranking models 120 can be received from the server computing system 130 over network 180, stored in the user computing device memory 114, and then used or otherwise implemented by the one or more processors 112. In some implementations, the user computing device 102 can implement multiple parallel instances of a single machine-learned ranking model 120 (e.g., to perform parallel ranking across multiple instances of pairwise inputs).

Additionally or alternatively, one or more machine-learned ranking models 140 can be included in or otherwise stored and implemented by the server computing system 130 that communicates with the user computing device 102 according to a client-server relationship. For example, the machine-learned ranking models 140 can be implemented by the server computing system 140 as a portion of a web service (e.g., a information retrieval service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned ranking models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned ranking models 120 and/or 140 based on a set of training data 162. The training data 162 can include, for example, inputs annotated with ground truth labels.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 7A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 7B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 7C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 7C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 7C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to perform listwise learning to rank with improved computational efficiency, the method comprising:
obtaining, by a computing system comprising one or more computing devices, a training example comprising a plurality of items and a plurality of signed labels respectively associated with the plurality of items, wherein the plurality of items comprises three or more items;
respectively processing, by the computing system, the plurality of items with a ranking model to respectively generate a plurality of intermediate scores respectively for the plurality of items;
determining, by the computing system, a single listwise probability collectively for the plurality of signed labels based at least in part on the plurality of signed labels and the plurality of intermediate scores;
evaluating, by the computing system, a ranking loss function based at least in part on the single listwise probability; and
modifying, by the computing system, one or more parameter values of the ranking model based at least in part on the ranking loss function.

2. The computer-implemented method of claim 1, wherein:
determining, by the computing system, the single listwise probability collectively for the plurality of signed labels comprises generating, by the computing system, a single listwise score collectively for the plurality of items based at least in part on the plurality of signed labels and the plurality of intermediate scores; and
evaluating, by the computing system, the ranking loss function based at least in part on the single listwise probability comprises evaluating, by the computing system, the ranking loss function based at least in part on the single listwise score.

3. The computer-implemented method of claim 2, wherein generating, by the computing system, the single listwise score comprises determining, by the computing system, a sum, for all of the plurality of items, of the signed label for each item multiplied by the intermediate score for such item.

4. The computer-implemented method of claim 2, wherein generating, by the computing system, the single listwise score comprises determining, by the computing system, a sum, for all of the plurality of items, of the signed label for each item multiplied by the intermediate score for such item multiplied by an importance weighting value for such item.

5. The computer-implemented method of claim 2, wherein generating, by the computing system, the single listwise score comprises determining, by the computing system, a difference between of a first value and a second value, wherein the first value comprises a first count of the signed labels that are negative valued multiplied by a first sum of the intermediate scores associated with items that have signed labels that are positive valued, and wherein the second value comprises a second count of the signed labels that are positive valued multiplied by a second sum of the intermediate scores associated with items that have signed labels that are negative valued.

6. The computer-implemented method of claim 5, wherein:
the first count comprises a first raw count, a first scaled count, a first normalized count, or a first exponentiated count; and
the second count comprises a second raw count, a second scaled count, a second normalized count, or a second exponentiated count.

7. The computer-implemented method of claim 2, wherein generating, by the computing system, the single listwise score comprises determining, by the computing system, a difference between of a first value and a second value, wherein the first value comprises a first count of the signed labels that are negative valued multiplied by a first sum, for all items that have signed labels that are positive valued, of the intermediate scores for such items multiplied by respective importance weighting values for such items, and wherein the second value comprises a second count of the signed labels that are positive valued multiplied by a second sum, for all items that have signed labels that are negative valued, of the intermediate scores for such items multiplied by respective importance weighting values for such items.

8. The computer-implemented method of claim 1, wherein determining, by the computing system, the single listwise probability collectively for the plurality of signed labels comprises determining, by the computing system, a value equal to one divided by a denominator, the denominator comprising one plus a sum, for all of the items, of an exponential function of a negative of the signed label for each item multiplied by the intermediate score for such item.

9. The computer-implemented method of claim 1, wherein determining, by the computing system, the single listwise probability collectively for the plurality of signed labels comprises determining, by the computing system, a value equal to one divided by a denominator, the denominator comprising one plus a sum, for all of the items, of a respective weighting value for each item multiplied by an exponential function of a negative of the signed label for such item multiplied by the intermediate score for such item.

10. The computer-implemented method of claim 1, wherein the ranking loss function comprises a negative logarithm of the single listwise probability.

11. The computer-implemented method of claim 1, wherein the ranking loss function comprises an identity function that equals one if at least two of the plurality of signed labels are inequal to each other and equals zero if all of the plurality of signed labels are equal to each other.

12. The computer-implemented method of claim 1, wherein at least two of the plurality of signed labels are positive valued.

13. One or more non-transitory computer-readable media that store instructions that, when executed by a computing system, cause the computing system to perform operations, the operations comprising:
obtaining, by a computing system comprising one or more computing devices, a training example comprising a plurality of items and a plurality of signed labels respectively associated with the plurality of items, wherein the plurality of items comprises three or more items;
respectively processing, by the computing system, the plurality of items with a teacher ranking model to respectively generate a plurality of intermediate teacher scores respectively for the plurality of items;
respectively processing, by the computing system, the plurality of items with a student ranking model to respectively generate a plurality of intermediate student scores respectively for the plurality of items;
evaluating, by the computing system, a distillation loss function based at least in part on the plurality of signed labels, the plurality of intermediate teacher scores, and the plurality of intermediate student scores; and
modifying, by the computing system, one or more parameter values of at least the student ranking model based at least in part on the distillation loss function.

14. The one or more non-transitory computer-readable media of claim 13, wherein evaluating, by the computing system, the distillation loss function comprises:
generating, by the computing system, a single listwise teacher score collectively for the plurality of items based at least in part on the plurality of signed labels and the plurality of intermediate teacher scores;
generating, by the computing system, a single listwise student score collectively for the plurality of items based at least in part on the plurality of signed labels and the plurality of intermediate student scores; and
evaluating, by the computing system, the distillation loss function based on a comparison of the single listwise teacher score and the single listwise student score.

15. The one or more non-transitory computer-readable media of claim 14, wherein:
generating, by the computing system, the single listwise teacher score comprises determining, by the computing system, a sum, for all of the plurality of items, of the signed label for each item multiplied by the intermediate teacher score for such item; and
generating, by the computing system, the single listwise student score comprises determining, by the computing system, a sum, for all of the plurality of items, of the signed label for each item multiplied by the intermediate student score for such item.

16. A computing system configured to perform operations, the operations comprising:
obtaining, by the computing system, a training example comprising a plurality of items and a plurality of signed labels respectively associated with the plurality of items, wherein the plurality of items comprises three or more items;
respectively processing, by the computing system, the plurality of items with a ranking model to respectively generate a plurality of intermediate scores respectively for the plurality of items;
evaluating, by the computing system, a ranking loss function based at least in part on the plurality of intermediate scores and the plurality of signed labels, wherein the ranking loss function evaluates a conditional label probability that is conditioned on a union of multiple conditioning events; and
modifying, by the computing system, one or more parameter values of the ranking model based at least in part on the ranking loss function.
